(19) United States
(12) Patent Application Publication
(10) Pub. No.: US 2020/0191586 A1
(43) Pub. Date: Jun. 18, 2020

(54) SYSTEMS AND METHODS FOR DETERMINING DRIVING PATH IN AUTONOMOUS DRIVING

(71) Applicant: BEIJING DIDI INFINITY TECHNOLOGY AND DEVELOPMENT CO., LTD., Beijing (CN)

(72) Inventor: Wei Luo, Beijing (CN)

(73) Assignee: BEIJING DIDI INFINITY TECHNOLOGY AND DEVELOPMENT CO., LTD., Beijing (CN)

(21) Appl. No.: 16/232,034

(22) Filed: Dec. 25, 2018

Related U.S. Application Data
(63) Continuation of application No. PCT/CN2018/122102, filed on Dec. 19, 2018.

(30) Foreign Application Priority Data
Dec. 18, 2018 (CN) 201811548158.7

(51) Int. Cl. G01C 21/34

(52) U.S. Cl. CPC G01C 21/3453; G05D 1/0088; G01C 21/3492

(57) ABSTRACT

The present disclosure relates to systems and methods for determining a driving path in autonomous driving. The systems may obtain a plurality of candidate driving paths; obtain one or more coefficients associated with the plurality of candidate driving paths based on a trained coefficient-generating model; determine a travel cost for each of the plurality of candidate driving paths based on the on one or more coefficients; and identify a target driving path from the plurality of candidate driving paths based on a plurality of travel costs corresponding to the plurality of candidate driving paths.

### CROSS-REFERENCE TO RELATED APPLICATIONS

This application is a continuation of International Application No. PCT/CN2018/122102 filed on Dec. 19, 2018 which designates the United States of America and claims priority to Chinese Patent Application No. 201811548158.7 filed on Dec. 18, 2018, the contents of which are incorporated herein by reference in their entirety.

### TECHNICAL FIELD

The present disclosure generally relates to systems and methods for autonomous driving, and in particular, to systems and methods for determining driving path in autonomous driving.

### BACKGROUND

With the development of micro-electronic and robotic technologies, the exploration of autonomous driving has developed rapidly nowadays. For an autonomous driving system, it is important to determine a suitable driving path based on driving information (e.g., a start location, a defined destination, road condition) associated with a vehicle of the autonomous driving system. Commonly, the autonomous driving system determines a plurality of candidate driving paths and selects a target driving path from the plurality of candidate driving paths based on a feature (e.g., a travel cost) associated with each of the plurality of candidate driving paths, and the feature associated with each of the plurality of candidate driving paths is generally determined based on artificially defined parameters. However, in some situations, the artificially defined parameters can be inaccurate or unsuitable and accordingly it would be difficult to determine the optimal driving path based on such parameters. Therefore, it is desirable to provide systems and methods for accurate and efficient determination of the optimal driving path, thereby improving performance of the autonomous driving system.

### SUMMARY

An aspect of the present disclosure relates to a system for determining a driving path in autonomous driving. The system may include at least one storage medium including a set of instructions and at least one processor in communication with the at least one storage medium. When executing the set of instructions, the at least one processor may be directed to cause the system to perform one or more of the following operations. The system may obtain a plurality of candidate driving paths. The system may obtain one or more coefficients associated with the plurality of candidate driving paths based on a trained coefficient-generating model. The system may determine a travel cost for each of the plurality of candidate driving paths based on the on one or more coefficients. The system may identify a target driving path from the plurality of candidate driving paths based on a plurality of travel costs corresponding to the plurality of candidate driving paths.

In some embodiments, the system may determine one or more cost parameters. The system may determine the travel cost for each of the plurality of candidate driving paths based on the one or more cost parameters and the one or more coefficients.

In some embodiments, the one or more cost parameters may include at least one of a speed cost parameter, a similarity cost parameter, and/or a jerk cost parameter.

In some embodiments, the trained coefficient-generating model may be determined with a training process. The training process may include obtaining a plurality of sample driving paths; determining a plurality of samples based on the plurality of sample driving paths, wherein each of the plurality of samples includes a set of sample driving paths corresponding to a same start location and a same destination; for each of the plurality of samples, determining a set of sample scores corresponding to the set of sample driving paths; and determining the trained coefficient-generating model based on the scores of the plurality of samples.

In some embodiments, the determining the trained coefficient-generating model based on the plurality of samples may include obtaining a preliminary coefficient-generating model including a plurality of preliminary coefficients, wherein each of the plurality of preliminary coefficients corresponds to a sample; extracting feature information of each of the plurality of samples; for each of the plurality of samples, determining a set of sample travel costs corresponding to the set of sample driving paths based on a corresponding preliminary coefficient and the feature information; determining whether a plurality of sets of sample travel costs and a plurality of sets of sample scores corresponding to the plurality of samples satisfy a preset condition; and designating the preliminary coefficient-generating model as the trained coefficient-generating model in response to the determination that the plurality of sets of sample travel costs and the plurality of sets of sample scores satisfy the preset condition.

In some embodiments, the determining the trained coefficient-generating model based on the plurality of samples may further include updating the plurality of preliminary coefficients in response to the determination that the plurality of sets of sample travel costs and the plurality of sets of sample scores do not satisfy the preset condition, and repeating the step of determining whether a plurality of sets of sample travel costs and a plurality of sets of sample scores corresponding to the plurality of samples satisfy the preset condition.

In some embodiments, the feature information of each of the plurality of samples may include velocity information of each of the set of sample driving paths and obstacle information associated with each of the set of sample driving paths.

In some embodiments, the system may identify a smallest travel cost from the plurality of travel costs. The system may identify a candidate driving path corresponding to the smallest travel cost as the target driving path.

In some embodiments, the system may transmit the target driving path to one or more control elements of a vehicle, directing the vehicle to follow the target driving path.

Another aspect of the present disclosure relates to a method implemented on a computing device. The computing device may include at least one processor, at least one storage medium, and a communication platform connected to a network. The method may include obtaining a plurality of candidate driving paths; obtaining one or more coefficients associated with the plurality of candidate driving paths based on a trained coefficient-generating model; determining a travel cost for each of the plurality of candidate driving paths based on the on one or more coefficients; and identifying a target driving path from the plurality of candidate driving paths based on a plurality of travel costs corresponding to the plurality of candidate driving paths.

In some embodiments, the determining the travel cost for each of the plurality of candidate driving paths may include determining one or more cost parameters; and determining the travel cost for each of the plurality of candidate driving paths based on the one or more cost parameters and the one or more coefficients.

In some embodiments, the one or more cost parameters may include at least one of a speed cost parameter, a similarity cost parameter, and/or a jerk cost parameter.

In some embodiments, the trained coefficient-generating model may be determined with a training process. The training process may include obtaining a plurality of sample driving paths; determining a plurality of samples based on the plurality of sample driving paths, wherein each of the plurality of samples includes a set of sample driving paths corresponding to a same start location and a same destination; for each of the plurality of samples, determining a set of sample scores corresponding to the set of sample driving paths; and determining the trained coefficient-generating model based on the scores of the plurality of samples.

In some embodiments, the determining the trained coefficient-generating model based on the plurality of samples may include obtaining a preliminary coefficient-generating model including a plurality of preliminary coefficients, wherein each of the plurality of preliminary coefficients corresponds to a sample; extracting feature information of each of the plurality of samples; for each of the plurality of samples, determining a set of sample travel costs corresponding to the set of sample driving paths based on a corresponding preliminary coefficient and the feature information; determining whether a plurality of sets of sample travel costs and a plurality of sets of sample scores corresponding to the plurality of samples satisfy a preset condition; and designating the preliminary coefficient-generating model as the trained coefficient-generating model in response to the determination that the plurality of sets of sample travel costs and the plurality of sets of sample scores satisfy the preset condition.

In some embodiments, the determining the trained coefficient-generating model based on the plurality of samples may further include updating the plurality of preliminary coefficients in response to the determination that the plurality of sets of sample travel costs and the plurality of sets of sample scores do not satisfy the preset condition, and repeating the step of determining whether a plurality of sets of sample travel costs and a plurality of sets of sample scores corresponding to the plurality of samples satisfy the preset condition.

In some embodiments, the feature information of each of the plurality of samples may include velocity information of each of the set of sample driving paths and obstacle information associated with each of the set of sample driving paths.

In some embodiments, the identifying the target driving path from the plurality of candidate driving paths based on the plurality of travel costs corresponding to the plurality of candidate driving paths may include identifying a smallest travel cost from the plurality of travel costs; and identifying a candidate driving path corresponding to the smallest travel cost as the target driving path.

In some embodiments, the method may further include transmitting the target driving path to one or more control elements of a vehicle, directing the vehicle to follow the target driving path.

A further aspect of the present disclosure relates to a vehicle configured for autonomous driving. The vehicle may include a detecting component, a planning component, and a control component. The planning component may be configured to obtain a plurality of candidate driving paths; obtain one or more coefficients associated with the plurality of candidate driving paths based on a trained coefficient-generating model; determine a travel cost for each of the plurality of candidate driving paths based on the on one or more coefficients; and identify a target driving path from the plurality of candidate driving paths based on a plurality of travel costs corresponding to the plurality of candidate driving paths.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting schematic embodiments, in which like reference numerals represent similar structures throughout the several views of the drawings, and wherein:

FIG. 1 is a schematic diagram illustrating an exemplary autonomous driving system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating an exemplary processing engine according to some embodiments of the present disclosure;

FIG. 4 is a flowchart illustrating an exemplary process for determining a driving path according to some embodiments of the present disclosure;

FIGS. 5-A, 5-B, and 5-C are schematic diagrams illustrating exemplary cost parameters of a travel cost according to some embodiments of the present disclosure;

FIG. 6 is a flowchart illustrating an exemplary process for determining a trained coefficient-generating model according to some embodiments of the present disclosure;

FIG. 7 is a schematic diagram illustrating an exemplary driving scenario according to some embodiments of the present disclosure; and

FIG. 8 is a schematic diagram illustrating an exemplary sample including a set of sample driving paths according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding a transportation system in land, it should be understood that this is only one exemplary embodiment. The systems and methods of the present disclosure may be applied to any other kind of transportation system. For example, the systems and methods of the present disclosure may be applied to transportation systems of different environments including ocean, aerospace, or the like, or any combination thereof. The vehicle of the transportation systems may include a car, a bus, a train, a subway, a vessel, an aircraft, a spaceship, a hot-air balloon, or the like, or any combination thereof.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for determining a driving path in autonomous driving. The systems and methods may obtain a plurality of candidate driving paths. The plurality of candidate driving paths may be determined based on driving information (e.g., road condition information, obstacle information) associated with a vehicle. The systems and methods may obtain one or more coefficients associated with the plurality of candidate driving paths based on a trained coefficient-generating model. The systems and methods may determine a travel cost for each of the plurality of candidate driving paths based on the on one or more coefficients. Further, the systems and methods may identify a target driving path (e.g., a candidate driving path corresponding to a smallest travel cost) from the plurality of candidate driving paths based on a plurality of travel costs corresponding to the plurality of candidate driving paths. According to the systems and methods of the present disclosure, the travel cost of a candidate driving path is determined based on coefficient(s) generated by a trained model, which can improve the accuracy of the path planning for the vehicle.

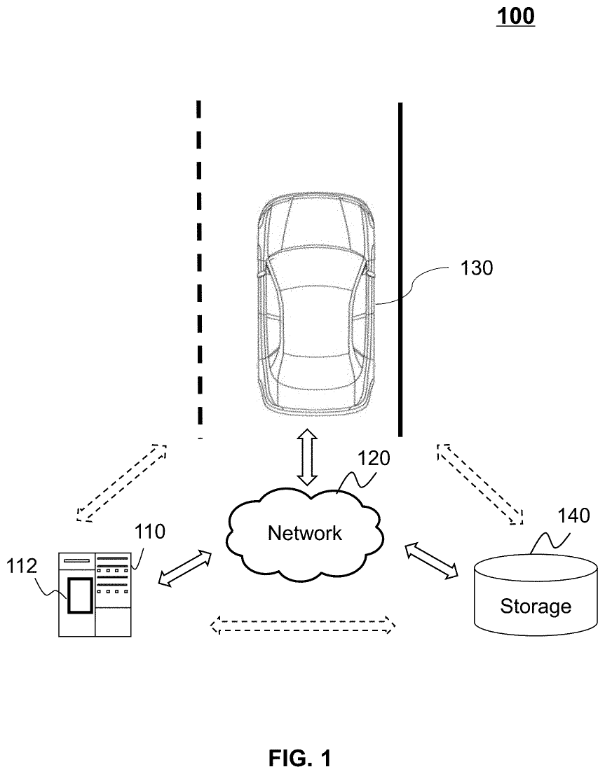

FIG. 1 is a schematic diagram illustrating an exemplary autonomous driving system according to some embodiments of the present disclosure. In some embodiments, the autonomous driving system 100 may include a server 110, a network 120, a vehicle 130, and a storage 140.

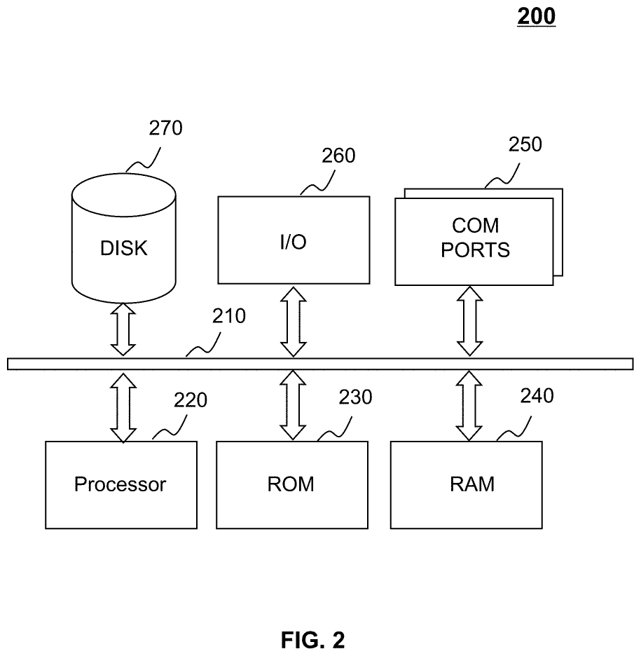

In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the vehicle 130 and/or the storage 140 via the network 120. As another example, the server 110 may be directly connected to the vehicle 130 and/or the storage 140 to access stored information and/or data. In some embodiments, the server 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 in the present disclosure.

In some embodiments, the server 110 may include a processing engine 112. The processing engine 112 may process information and/or data associated with driving information of the vehicle 130 to perform one or more functions described in the present disclosure. For example, the processing engine 112 may obtain driving information (e.g., road condition information, obstacle information) associated with the vehicle 130 and determine a driving path for the vehicle 130 based on the driving information. That is, the processing engine 112 may be configured as a planning component of the vehicle 130. As another example, the processing engine 112 may determine control instructions (e.g., a velocity control instruction, a direction control instruction) based on the driving path. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 110 may be connected to the network 120 to communicate with one or more components (e.g., the vehicle 130, the storage 140) of the autonomous driving system 100. In some embodiments, the server 110 may be directly connected to or communicate with one or more components (e.g., the vehicle 130, the storage 140) of the autonomous driving system 100. In some embodiments, the server 110 may be integrated in the vehicle 130. For example, the server 110 may be a computing device (e.g., an on-board computer) installed in the vehicle 130.

The network 120 may facilitate exchange of information and/or data. In some embodiments, one or more components (e.g., the server 110, the vehicle 130, the storage 140) of the autonomous driving system 100 may send information and/or data to other component(s) of the autonomous driving system 100 via the network 120. For example, the server 110 may obtain driving information associated with the vehicle 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points, through which one or more components of the autonomous driving system 100 may be connected to the network 120 to exchange data and/or information.

The vehicle 130 may be any type of autonomous vehicle. The autonomous vehicle may be capable of sensing environmental information and navigating without human maneuvering. The vehicle 130 may include structures of a conventional vehicle. For example, the vehicle 130 may include a plurality of control elements configured to control operations of the vehicle 130. The plurality of control elements may include a steering device (e.g., a steering wheel), a brake device (e.g., a brake pedal), an accelerator, etc. The steering device may be configured to adjust a heading and/or a direction of the vehicle 130. The brake device may be configured to perform a braking operation to stop the vehicle 130. The accelerator may be configured to control a velocity and/or an acceleration of the vehicle 130.

The vehicle 130 may also include a plurality of detection units configured to detect driving information associated with the vehicle 130. The plurality of detection units may include a camera, a global position system (GPS) module, an acceleration sensor (e.g., a piezoelectric sensor), a velocity sensor (e.g., a Hall sensor), a distance sensor (e.g., a radar, a LIDAR, an infrared sensor), a steering angle sensor (e.g., a tilt sensor), a traction-related sensor (e.g., a force sensor), etc. In some embodiments, the driving information associated with the vehicle 130 may include perception information (e.g., road condition information, obstacle information) within a range of the vehicle 130, map information within the range of the vehicle 130, etc.

The storage 140 may store data and/or instructions. In some embodiments, the storage 140 may store data obtained from the vehicle 130, such as driving information associated with the vehicle 130 acquired by the plurality of detection units. In some embodiments, the storage 140 may store data and/or instructions that the server 110 may execute or use to perform exemplary methods described in the present disclosure. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components (e.g., the server 110, the vehicle 130) of the autonomous driving system 100. One or more components of the autonomous driving system 100 may access the data or instructions stored in the storage 140 via the network 120. In some embodiments, the storage 140 may be directly connected to or communicate with one or more components (e.g., the server 110 and the vehicle 130) of the autonomous driving system 100. In some embodiments, the storage 140 may be part of the server 110. In some embodiments, the storage 140 may be integrated in the vehicle 130.

It should be noted that the autonomous driving system 100 is merely provided for the purposes of illustration, and is not intended to limit the scope of the present disclosure. For persons having ordinary skills in the art, multiple variations or modifications may be made under the teachings of the present disclosure. For example, the autonomous driving system 100 may further include a database, an information source, etc. As another example, the autonomous driving system 100 may be implemented on other devices to realize similar or different functions. However, those variations and modifications do not depart from the scope of the present disclosure.

FIG. 2 is a schematic diagram illustrating exemplary hardware and software components of an exemplary computing device according to some embodiments of the present disclosure. In some embodiments, the server 110 may be implemented on the computing device 200. For example, the processing engine 112 may be implemented on the computing device 200 and configured to perform functions of the processing engine 112 disclosed in this disclosure.

The computing device 200 may be used to implement any component of the autonomous driving system 100 of the present disclosure. For example, the processing engine 112 of the autonomous driving system 100 may be implemented on the computing device 200, via its hardware, software program, firmware, or a combination thereof. Although only one such computer is shown for convenience, the computer functions related to the autonomous driving system 100 as described herein may be implemented in a distributed manner on a number of similar platforms to distribute the processing load.

The computing device 200, for example, may include communication (COMM) ports 250 connected to and from a network (e.g., the network 120) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read only memory (ROM) 230, or a random access memory (RAM) 240, for storing various data files to be processed and/or transmitted by the computing device 200. The computing device 200 may also include program instructions stored in the ROM 230, the RAM 240, and/or other type of non-transitory storage medium to be executed by the processor 220. The methods and/or processes of the present disclosure may be implemented as the program instructions. The computing device 200 also includes an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As in another example, operation A and operation B may also be performed by two different processors jointly or separately in the computing device 200 (e.g., the first processor executes operation A and the second processor executes operation B, or the first and second processors jointly execute operations A and B).

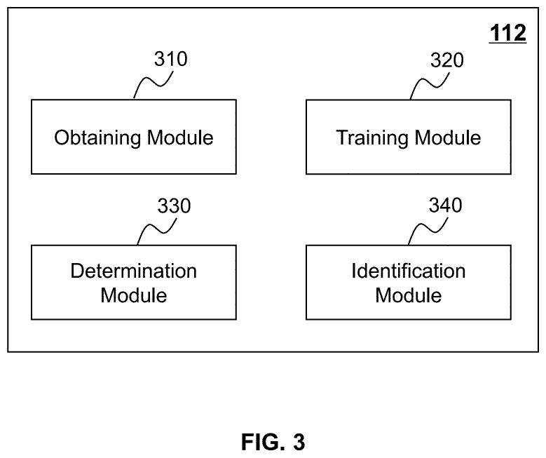

FIG. 3 is a block diagram illustrating an exemplary processing engine according to some embodiments of the present disclosure. The processing engine 112 may include an obtaining module 310, a training module 320, a determination module 330, and an identification module 340.

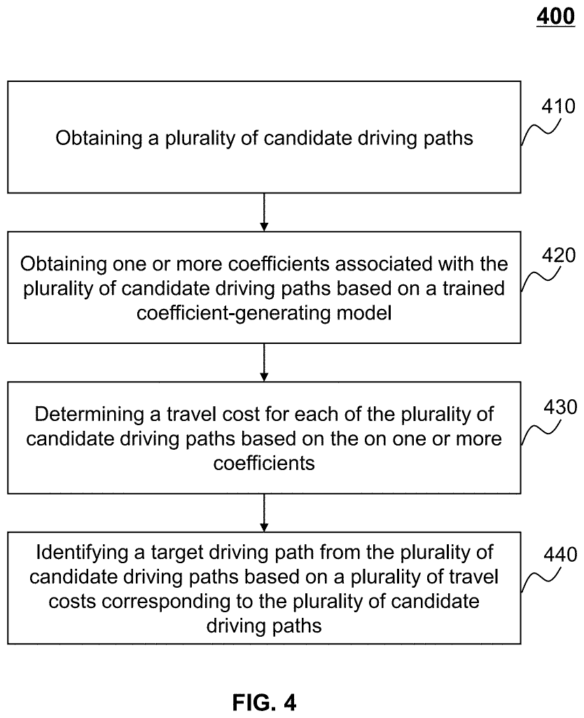

The obtaining module 310 may be configured to obtain a plurality of candidate driving paths associated with a vehicle (e.g., the vehicle 130). In some embodiments, the obtaining module 310 may obtain the plurality of candidate driving paths from a storage device (e.g., the storage 140) such as the ones disclosed elsewhere in the present disclosure. In some embodiments, the obtaining module 310 may determine the plurality of candidate driving paths based on driving information (e.g., a current location of the vehicle, a current velocity of the vehicle, a current acceleration of the vehicle, a defined destination, road condition, obstacle information) associated with the vehicle. More descriptions regarding the plurality of candidate driving paths may be found elsewhere in the present disclosure (e.g., FIG. 4 and the descriptions thereof).

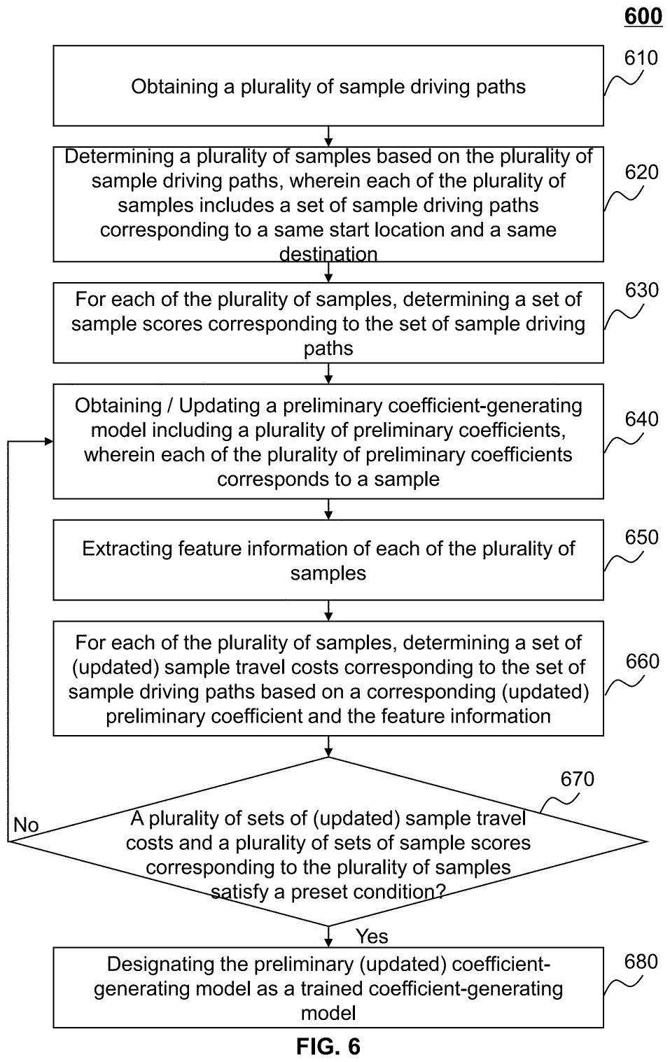

The training module 320 may be configured to determine a trained coefficient-generating model based on a plurality of samples. Each of the plurality of samples may include a set of sample driving paths corresponding to a same start location and a same destination. More descriptions of the trained coefficient-generating model may be found elsewhere in the present disclosure (e.g., FIG. 6 and the descriptions thereof).

The determination module 330 may be configured to obtain one or more coefficients associated with the plurality of candidate driving paths based on a trained coefficient-generating model. The determination module 330 may also be configured to determine a travel cost for each of the plurality of candidate driving paths based on the on one or more coefficients. In some embodiments, the determination module 330 may determine one or more cost parameters and determine the travel cost for each of the plurality of candidate driving paths based on the one or more cost parameters and the one or more coefficients. More descriptions regarding the travel cost may be found elsewhere in the present disclosure (e.g., FIG. 4 and the descriptions thereof).

The identification module 340 may be configured to identify a target driving path from the plurality of candidate driving paths based on a plurality of travel costs corresponding to the plurality of candidate driving paths. In some embodiments, the identification module 340 may identify a smallest travel cost from the plurality of travel costs and identify a candidate driving path corresponding to the smallest travel cost as the target driving path.

In some embodiments, the processing engine 112 may further include a transmission module (not shown) which may be configured to transmit the target driving path to one or more control elements (e.g., a braking device, an accelerator) of the vehicle and direct the vehicle to follow the target driving path.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the determination module 330 and the identification module 340 may be combined as a single module which may both determine a travel cost for each of the plurality of candidate driving paths and identify the target driving path from the plurality of candidate driving paths. As another example, the obtaining module may also be configured to obtain the one or more coefficients associated with the plurality of candidate driving paths. As a further example, the processing engine 112 may include a storage module (not shown in FIG. 3) which may be configured to store the plurality of candidate driving paths, the plurality of travel costs corresponding to the plurality of candidate driving paths, the target driving path, etc. As a still further example, the training module 320 may be unnecessary and the trained coefficient-generating model may be obtained from a storage device (e.g., the storage 140), such as the ones disclosed elsewhere in the present disclosure.

FIG. 4 is a flowchart illustrating an exemplary process for determining a driving path according to some embodiments of the present disclosure. The process 400 may be executed by the autonomous driving system 100. For example, the process 400 may be implemented as a set of instructions (e.g., an application) stored in the storage ROM 230 or RAM 240. The processor 220 and/or the modules illustrated in FIG. 3 may execute the set of instructions, and when executing the instructions, the processor 220 and/or the modules may be configured to perform the process 400. The operations of the illustrated process/method presented below are intended to be illustrative. In some embodiments, the process 400 may be accomplished with one or more additional operations not described and/or without one or more of the operations discussed. Additionally, the order in which the operations of the process 400 illustrated in FIG. 4 and described below is not intended to be limiting.

In 410, the processing engine 112 (e.g., the obtaining module 310) (e.g., the interface circuits of the processor 220) may obtain a plurality of candidate driving paths associated with a vehicle (e.g., the vehicle 130).

In some embodiments, the processing engine 112 may obtain the plurality of candidate driving paths from a storage device (e.g., the storage 140) such as the ones disclosed elsewhere in the present disclosure. In some embodiments, the processing engine 112 may determine the plurality of candidate driving paths based on driving information (e.g., a current location of the vehicle, a current velocity of the vehicle, a current acceleration of the vehicle, a defined destination, road condition, obstacle information) associated with the vehicle. For example, the processing engine 112 may determine a plurality of curves associated with the current location of the vehicle and the defined destination based on a curve-fitting method and select curves which do not collide with obstacle(s) as the plurality of candidate driving paths. As another example, the processing engine 112 may determine the plurality of candidate driving paths based on the driving information associated with the vehicle according to a machine learning model (e.g., an artificial neural network model, a support vector machine (SVM) model, a decision tree model). More descriptions for determining the candidate driving paths may be found in International Application No. PCT/CN2017/092714 filed on Jul. 13, 2017, the entire contents of which are incorporated herein by reference in their entirety.

In some embodiments, the processing engine 112 determine a difference between each of the plurality of candidate driving paths and a previous target driving path corresponding to a previous time point. Further, the processing engine 112 may filter out candidate driving path(s) with difference(s) larger than a difference threshold (which may be default settings or may be adjustable) and determine the remainder of the plurality of candidate driving paths as the final candidate driving paths. It should be noted that the autonomous driving system 100 may determine driving paths according to a predetermined time interval (e.g., 5 ms, 10 ms, 15 ms, 20 ms), that is, the autonomous driving system 100 may determine a first target driving path at a first time point and a second target driving path at a second time point, wherein the first time point and the second time point are separated by the predetermined time interval and may be designated as “adjacent time points.” Accordingly, a previous time point used herein refers to an adjacent time point before a current time point.

In 420, the processing engine 112 (e.g., the obtaining module 310 or the determination module 330) (e.g., the processing circuits of the processor 220) may obtain one or more coefficients associated with the plurality of candidate driving paths based on a trained coefficient-generating model. The processing engine 112 may obtain the trained coefficient-generating model from the training module 320 or a storage device (e.g., the storage 140), such as the ones disclosed elsewhere in the present disclosure. The coefficient-generating model may be trained based on a plurality of sample driving paths. More descriptions of the trained coefficient-generating model may be found elsewhere in the present disclosure (e.g., FIG. 6 and the descriptions thereof).

In 430, the processing engine 112 (e.g., the determination module 330) (e.g., the processing circuits of the processor 220) may determine a travel cost for each of the plurality of candidate driving paths based on the on one or more coefficients. In some embodiments, the processing engine 112 may determine one or more cost parameters and determine the travel cost for each of the plurality of candidate driving paths based on the one or more cost parameters and the one or more coefficients. Take a specific candidate driving path as an example, the processing engine 112 may determine the travel cost for the specific candidate driving path according to formula (1) below:

F_{cost}=Σᵢ₌₁ⁿwᵢ×cᵢ (1)

where F_{cost} refers to the travel cost for the specific candidate driving path, cᵢ refers to an ith cost parameter of the specific candidate driving path, wᵢ refers to an ith coefficient corresponding to the ith cost parameter, and n refers to a number count of the one or more cost parameters.

In some embodiments, the one or more cost parameters may include a speed cost parameter, a similarity cost parameter, a jerk cost parameter, etc. As used herein, also take a specific candidate driving path as an example, the speed cost parameter indicates speed difference information among a plurality of points on the specific candidate driving path; the similarity cost parameter indicates similarity information between the specific candidate driving path and a previous target driving path corresponding to a previous time point; the jerk cost parameter indicates smoothness information associated with the specific candidate driving path.

In some embodiments, the processing engine 112 may determine the speed cost parameter according to formula (2) below:

S_{cost}=Σᵢ₌₁^{m}(vᵢ₊₁−vᵢ)² (2)

where S_{cost} refers to the speed cost parameter, vᵢ refers to a speed of an ith point on the specific candidate driving path, vᵢ₊₁ refers to a speed of a (i+1)th point on the specific candidate driving path, and m refers to a number count of the plurality of points on the specific candidate driving path. In some embodiments, a time interval between two adjacent points (i.e., the ith point and the (i+1)th point) on the specific candidate driving path may be default settings (e.g., 5 ms, 10 ms, 15 ms, 20 ms) of the autonomous driving system 100 or may be adjustable under different situations.

In some embodiments, the processing engine 112 may determine the similarity cost parameter according to formula (3) below:

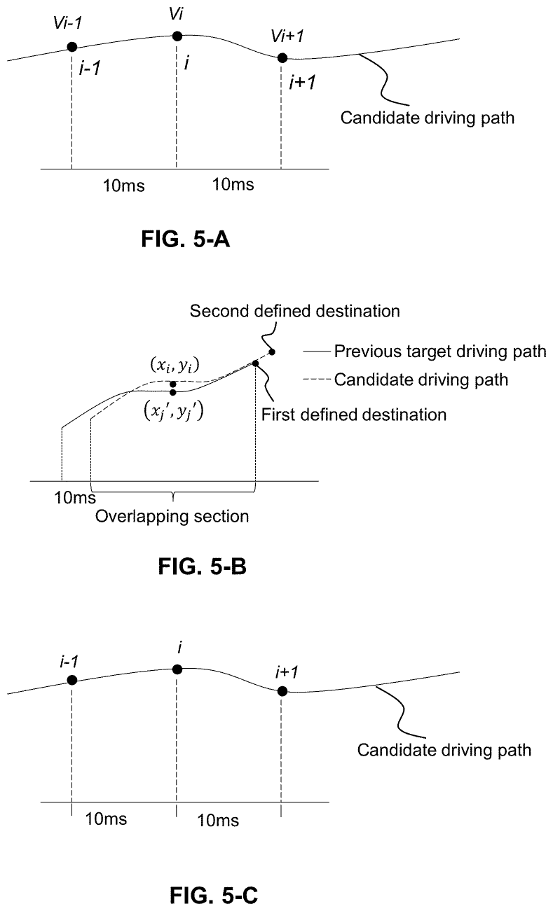

Similarity_{cost}=Σᵢ₌₁^{p}(xᵢ−xⱼ′)²+(yᵢ+yⱼ′)² (3)

where Similarity_{cost} refers to the similarity cost parameter, (xᵢ, yᵢ) refers to an ith point on the specific candidate driving path, (xⱼ′, yⱼ′) refers to a jth point on the previous target driving path corresponding to the previous time point (where the jth point is a nearest point on the previous target driving path to the ith point on the candidate driving path corresponding to the previous time point), and p refers to a number count of points within an overlapping section (e.g., an overlapping section illustrated in FIG. 5-B) of the specific candidate driving path and the previous target driving path corresponding to the previous time point.

In some embodiments, the processing engine 112 may determine the jerk cost parameter based on a global curvature of the specific candidate driving path. For example, the processing engine 112 may determine a curvature of each point on the specific candidate driving path and determine a sum of a plurality of curvatures corresponding to the plurality of points on the specific candidate driving path as the global curvature. As another example, the processing engine 112 may determine an average (or a weighted average) of the plurality of curvatures corresponding to the plurality of points on the specific candidate driving path as the global curvature.

In 440, the processing engine 112 (e.g., the identification module 340) (e.g., the processing circuits of the processor 220) may identify a target driving path from the plurality of candidate driving paths based on a plurality of travel costs corresponding to the plurality of candidate driving paths. In some embodiments, the processing engine 112 may identify a smallest travel cost from the plurality of travel costs and identify a candidate driving path corresponding to the smallest travel cost as the target driving path.

In some embodiments, the processing engine 112 may further transmit the target driving path to one or more control elements (e.g., a braking device, an accelerator) of the vehicle and direct the vehicle to follow the target driving path. For example, the processing engine 112 may determine control commands associated with the target driving path and transmit the control commands to the one or more control elements.

As described above, the autonomous driving system determines the target driving path based on travel costs corresponding to the candidate driving paths, which are determined based on the one or more coefficients (which can be obtained based on the trained coefficient-generating model). It should be noted that the autonomous driving system is a real time or substantially real time system, which needs rapid calculation and reaction. However, it needs time (although very short) to determine the one or more coefficients based on the trained coefficient-generating model, and cumulative time may result in a decision delay. Therefore, in some situations (e.g., simple road condition (e.g., a straight road)), artificially defined coefficients may be used to reduce computing time and ensure the normal operation of the autonomous driving system.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing operation) may be added elsewhere in the process 400. In the storing operation, the processing engine 112 may store the plurality of candidate driving paths, the plurality of travel costs corresponding to the plurality of candidate driving paths, the target driving path, etc. As another example, the one or more cost parameters may also include other parameters associated with one or more features (e.g., a distance between the candidate driving path and an obstacle, a travel time of the candidate driving path) of the candidate driving path.

FIGS. 5-A, 5-B, and 5-C are schematic diagrams illustrating exemplary cost parameters of a travel cost according to some embodiments of the present disclosure. As described in connection with operation 430, the cost parameters may include a speed cost parameter, a similarity cost parameter, a jerk cost parameter, etc.

As illustrated in FIG. 5-A, a candidate driving path includes a plurality of points and a time interval between two adjacent points (e.g., point i and point (i+1)) is 10 ms. According to formula (2), the processing engine 112 may determine the speed cost parameter based on a plurality of speed differences between any two adjacent points (e.g., a speed difference between vᵢ and vᵢ₊₁) on the candidate driving path.

As illustrated in FIG. 5-B, a solid line refers to a previous target driving path corresponding to a previous time point and a dashed line refers to a candidate driving path. The previous target driving path may be determined at the previous time point based on a location of the vehicle at the previous time point and a first defined destination. The candidate driving path may be determined at a current time point based on a current location of the vehicle and a second defined destination (which is the same as or different from the first defined destination). The processing engine 112 may determine the similarity cost parameter based on points within an overlapping section between the previous target driving path and the candidate driving path. As illustrated, a jth point is a nearest point on the previous target driving path to an ith point on the candidate driving path. According to formula (3), the processing engine 112 may determine the similarity cost parameter based on a plurality of differences associated with a plurality of point pairs (e.g., the ith point on the candidate driving path and the jth point on the previous target driving path path).

As illustrated in FIG. 5-C, a candidate driving path includes a plurality of points and a time interval between two adjacent (e.g., point i and point (i+1)) is 10 ms. The processing engine 112 may determine a global curvature (e.g., a sum or an average of a plurality of curvatures corresponding to the plurality of points) as the jerk cost parameter.

It should be noted that the exemplary cost parameters are provided for illustration purposes and not intended to be limiting, the processing engine 112 may also determine other cost parameters associated with one or more features (e.g., a distance between the candidate driving path and an obstacle, a travel time of the candidate driving path) of the candidate driving path.

FIG. 6 is a flowchart illustrating an exemplary process for determining a trained coefficient-generating model according to some embodiments of the present disclosure. The process 600 may be executed by the autonomous driving system 100. For example, the process 600 may be implemented as a set of instructions (e.g., an application) stored in the storage ROM 230 or RAM 240. The processor 220 and/or the training module 320 may execute the set of instructions, and when executing the instructions, the processor 220 and/or the training module 320 may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIG. 6 and described below is not intended to be limiting.

In 610, the processing engine 112 (e.g., the training module 320) (e.g., the interface circuits of the processor 220) may obtain a plurality of sample driving paths. The processing engine 112 may obtain the plurality of sample driving paths from a storage device (e.g., the storage 140, a storage module (not shown) integrated in the processing engine 112), such as the ones disclosed elsewhere in the present disclosure. A number count of the plurality of sample driving paths may be default settings (e.g., 256, 512, 1024) of the autonomous driving system 100 or may be adjustable under different situations. In some embodiments, the plurality of sample driving paths may include actual driving paths obtained based on GPS information or simulated driving paths.

For example, the processing engine 112 may define a plurality of driving scenarios and direct a driver to actually drive a test vehicle in the plurality of driving scenarios. As used herein, the driving scenario may include road condition (e.g., expressway, beltway, side road, flyover, lane information), driving situation (e.g., straight, 90° left-hand bend, 60° left-hand bend, 30° left-hand bend, 90° right-hand bend, 60° right-hand bend, 30° right-hand bend, turn around), weather information, etc. A terminal (e.g., a mobile device), an automobile data recorder, or a GPS device associated with the test vehicle may collect GPS information during the driving. Further, the processing engine 112 may obtain actual driving paths based on the GPS information associated with the plurality of driving scenarios as the plurality of sample driving paths.

As another example, the processing engine 112 may obtain a plurality of historical driving routes associated with a plurality of historical service orders (e.g., taxi-hailing services) and determine the plurality of sample driving paths based on the plurality of historical driving routes. Take a specific historical service order as an example, during the service order, a requester terminal associated with a passenger of the service order, a provider terminal associated with a driver of the service order, and/or a GPS device integrated in a vehicle of the service order may periodically transmit GPS information to the processing engine 112 (e.g., the training module 320) or a storage device (e.g., the storage 140) disclosed elsewhere in the present disclosure. Further, according to the GPS information, the processing engine 112 may determine a corresponding historical driving route or a portion of the historical driving route as a sample driving path.

As a further example, the processing engine 112 may simulate operation of the vehicle based on one or more features (e.g., vehicle type, vehicle weight, vehicle model) of the vehicle and the plurality of driving scenarios, and obtain a plurality of simulated driving paths as the plurality of sample driving paths.

In 620, the processing engine 112 (e.g., the training module 320) (e.g., the processing circuits of the processor 220) may determine a plurality of samples based on the plurality of sample driving paths, wherein each of the plurality of samples includes a set of sample driving paths corresponding to a same start location and a same destination. In some embodiments, the processing engine 112 may divide the plurality of samples into a training set and a test set.

In 630, for each of the plurality of samples, the processing engine 112 (e.g., the training module 320) (e.g., the processing circuits of the processor 220) may determine a set of sample scores corresponding to the set of sample driving paths. As used herein, a sample score is a value within a predetermined range (e.g., 0-1) and may be associated with one or more features of the sample driving path, for example, an offset from the sample driving path to a center line of a lane, a travel time of the sample driving path, a comfort level of the sample driving path, etc.

In some embodiments, the larger the offset from the sample driving path to the center line of the lane is, the lower the sample score of the sample driving path may be; the longer the travel time of the sample driving path is, the lower the sample score of the sample driving path may be; the lower the comfort level of the sample driving path is, the lower the sample score of the sample driving path may be. As used herein, the comfort level may be associated with a plurality of accelerations corresponding to a plurality of points on the sample driving path. For example, it is assumed that each of the plurality of accelerations is less than a first acceleration threshold (e.g., 3 m/s²), the comfort level may be specified as 1, whereas, it is assumed that a percentage of accelerations which are larger than a second acceleration threshold (e.g., 10 m/s²) is larger than a percentage threshold (e.g., 50%, 60%, 70%), the comfort level may be specified as 0. Accordingly, the larger the percentage of accelerations which are larger than the second acceleration threshold is, the lower the comfort level of the sample driving path may be.

In 640, the processing engine 112 (e.g., the training module 320) (e.g., the processing circuits of the processor 220) may obtain a preliminary coefficient-generating model including a plurality of preliminary coefficients, wherein each of the plurality of preliminary coefficients corresponds to a sample. It should be noted that a singular “preliminary coefficient” is used herein for convenience and the “preliminary coefficient” refers to one or more preliminary coefficients corresponding to one or more cost parameters respectively.

In some embodiments, the preliminary coefficient-generating model may be a supervised learning model. In some embodiments, the preliminary coefficient-generating model may include a preliminary Convolutional Neural Network (CNN) model, a preliminary Recurrent Neural Network (RNN) model, etc. The preliminary coefficient-generating model may be default settings of the system 100 or may be adjustable under different situations.

In 650, the processing engine 112 (e.g., the training module 320) (e.g., the processing circuits of the processor 220) may extract feature information of each of the plurality of samples. In some embodiments, the feature information of each of the plurality of samples may include velocity information of each of the set of sample driving paths, obstacle information associated with each of the set of sample driving paths, travel time of each of the set of sample driving paths, etc.

In 660, for each of the plurality of samples, the processing engine 112 (e.g., the training module 320) (e.g., the processing circuits of the processor 220) may determine a set of sample travel costs corresponding to the set of sample driving paths based on a corresponding preliminary coefficient and the feature information. As described in connection with operation 430, the processing engine 112 may determine the set of sample travel costs according to formula (1).

In 670, the processing engine 112 (e.g., the training module 320) (e.g., the processing circuits of the processor 220) may determine whether a plurality of sets of sample travel costs and a plurality of sets of sample scores corresponding to the plurality of samples satisfy a preset condition.

For example, for each of the plurality of samples, the processing engine 112 may determine whether the set of sample travel costs are negatively related to the set of sample scores. In response to the determination that the set of sample travel costs are negatively related to the set of sample scores, it may be determined that the plurality of sets of sample travel costs and the plurality of sets of sample scores corresponding to the plurality of samples satisfy the preset condition.

As another example, the processing engine 112 may determine a loss function of the preliminary coefficient-generating model and determine a value of the loss function based on the plurality of sets of sample travel costs and the plurality of sets of sample scores. Further, the processing engine 112 may determine whether the value of the loss function is less than a loss threshold. In response to the determination that the value of the loss function is less than the loss threshold, it may be determined that the plurality of sets of sample travel costs and the plurality of sets of sample scores corresponding to the plurality of samples satisfy the preset condition.

As a further example, the processing engine 112 may determine whether an accuracy rate of the preliminary coefficient-generating model is larger than an accuracy rate threshold. In response to the determination that the accuracy rate is larger than the accuracy rate threshold, it may be determined that the plurality of sets of sample travel costs and the plurality of sets of sample scores corresponding to the plurality of samples satisfy the preset condition.

As still a further example, the processing engine 112 may determine whether a number count of iterations is larger than a count threshold. In response to the determination that the number count of iterations is larger than the count threshold, it may be determined that the plurality of sets of sample travel costs and the plurality of sets of sample scores corresponding to the plurality of samples satisfy the preset condition.

As still a further example, the processing engine 112 may test the preliminary coefficient-generating model based on the test data and determine whether a test result (e.g., a test accuracy rate) is larger than a test threshold. In response to the determination that the test result is larger than the test threshold, it may be determined that the plurality of sets of sample travel costs and the plurality of sets of sample scores corresponding to the plurality of samples satisfy the preset condition.

In response to the determination that the plurality of sets of sample travel costs and the plurality of sets of sample scores corresponding to the plurality of samples satisfy the preset condition, the processing engine 112 (e.g., the training module 320) (e.g., the processing circuits of the processor 220) may designate the preliminary coefficient-generating model as the trained coefficient-generating model in 680, which means that the training process has been completed.

In response to the determination that the plurality of sets of sample travel costs and the plurality of sets of sample scores corresponding to the plurality of samples do not satisfy the preset condition, the processing engine 112 (e.g., the training module 320) (e.g., the processing circuits of the processor 220) may execute the process 600 to return to 640 to update the plurality of preliminary coefficients (i.e., to update the preliminary coefficient-generating model).

Further, the processing engine 112 may determine whether a plurality of sets of updated sample travel costs and the plurality of sets of sample scores corresponding to the plurality of samples satisfy the preset condition. In response to the determination that the plurality of sets of updated sample travel costs and the plurality of sets of sample scores satisfy the preset condition, the processing engine 112 may designate the updated coefficient-generating model as the trained coefficient-generating model. On the other hand, in response to the determination that the plurality of sets of updated sample travel costs and the plurality of sets of sample scores corresponding to the plurality of samples do not satisfy the preset condition, the processing engine 112 may still execute the process 600 to return to 640 to update the updated coefficient-generating model until the plurality of sets of updated sample travel costs and the plurality of sets of sample scores corresponding to the plurality of samples satisfy the preset condition.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the training module 320 may update the trained coefficient-generating model at a certain time interval (e.g., per month, per two months) based on a plurality of newly obtained samples.

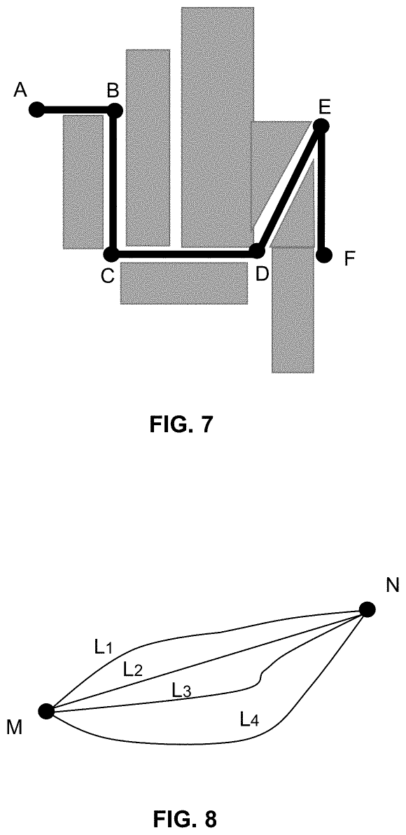

FIG. 7 is a schematic diagram illustrating an exemplary driving scenario according to some embodiments of the present disclosure. As illustrated, point A refers to a start location and point F refers to a defined destination. The driving scenario includes straight sections (e.g., AB, BC, CD, DE, and EF), a 90° right-hand bend (e.g., from AB to BC), a 150° right-hand bend (e.g., from DE to EF), a 90° left-hand bend (e.g., from BC to CD), a 60° left-hand bend (e.g., from CD to DE), etc.

FIG. 8 is a schematic diagram illustrating an exemplary sample including a set of sample driving paths according to some embodiments of the present disclosure. As illustrated, M refers to a start location and N refers to a defined destination. A sample includes a set of sample driving paths (e.g., L₁, L₂, L₃, and L₄) corresponding to the same start location and the same destination.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining a driving path in autonomous driving, comprising:
at least one storage medium including a set of instructions; and
at least one processor in communication with the at least one storage medium, wherein when executing the set of instructions, the at least one processor is directed to cause the system to:
obtain a plurality of candidate driving paths;
obtain one or more coefficients associated with the plurality of candidate driving paths based on a trained coefficient-generating model;
determine a travel cost for each of the plurality of candidate driving paths based on the on one or more coefficients; and
identify a target driving path from the plurality of candidate driving paths based on a plurality of travel costs corresponding to the plurality of candidate driving paths.

2. The system of claim 1, wherein to determine the travel cost for each of the plurality of candidate driving paths, the at least one processor is directed to cause the system to:
determine one or more cost parameters; and
determine the travel cost for each of the plurality of candidate driving paths based on the one or more cost parameters and the one or more coefficients.

3. The system of claim 2, wherein the one or more cost parameters include at least one of a speed cost parameter, a similarity cost parameter, or a jerk cost parameter.

4. The system of claim 2, wherein the one or more cost parameters include a speed cost parameter, a similarity cost parameter, and a jerk cost parameter.

5. The system of claim 1, wherein the trained coefficient-generating model is determined with a training process, the training process comprising:
obtaining a plurality of sample driving paths;
determining a plurality of samples based on the plurality of sample driving paths, wherein each of the plurality of samples includes a set of sample driving paths corresponding to a same start location and a same destination;
for each of the plurality of samples, determining a set of sample scores corresponding to the set of sample driving paths; and
determining the trained coefficient-generating model based on the scores of the plurality of samples.

6. The system of claim 5, wherein the determining the trained coefficient-generating model based on the plurality of samples includes:
obtaining a preliminary coefficient-generating model including a plurality of preliminary coefficients, wherein each of the plurality of preliminary coefficients corresponds to a sample;
extracting feature information of each of the plurality of samples;
for each of the plurality of samples, determining a set of sample travel costs corresponding to the set of sample driving paths based on a corresponding preliminary coefficient and the feature information;
determining whether a plurality of sets of sample travel costs and a plurality of sets of sample scores corresponding to the plurality of samples satisfy a preset condition; and
designating the preliminary coefficient-generating model as the trained coefficient-generating model in response to the determination that the plurality of sets of sample travel costs and the plurality of sets of sample scores satisfy the preset condition.

7. The system of claim 6, wherein the determining the trained coefficient-generating model based on the plurality of samples further includes:
updating the plurality of preliminary coefficients in response to the determination that the plurality of sets of sample travel costs and the plurality of sets of sample scores do not satisfy the preset condition, and
repeating the step of determining whether a plurality of sets of sample travel costs and a plurality of sets of sample scores corresponding to the plurality of samples satisfy the preset condition.

8. The system of claim 6, wherein the feature information of each of the plurality of samples includes velocity information of each of the set of sample driving paths and obstacle information associated with each of the set of sample driving paths.

9. The system of claim 1, wherein to identify the target driving path from the plurality of candidate driving paths based on the plurality of travel costs corresponding to the plurality of candidate driving paths, at least one processor is directed to cause the system to:
identify a smallest travel cost from the plurality of travel costs; and
identify a candidate driving path corresponding to the smallest travel cost as the target driving path.

10. The system of claim 1, wherein the at least one processor is directed to cause the system further to:
transmit the target driving path to one or more control elements of a vehicle, directing the vehicle to follow the target driving path.

11. A method implemented on a computing device having at least one processor, at least one storage medium, and a communication platform connected to a network, the method comprising:
obtaining a plurality of candidate driving paths;
obtaining one or more coefficients associated with the plurality of candidate driving paths based on a trained coefficient-generating model;
determining a travel cost for each of the plurality of candidate driving paths based on the on one or more coefficients; and
identifying a target driving path from the plurality of candidate driving paths based on a plurality of travel costs corresponding to the plurality of candidate driving paths.

12. The method of claim 11, wherein the determining the travel cost for each of the plurality of candidate driving paths includes:
determining one or more cost parameters; and
determining the travel cost for each of the plurality of candidate driving paths based on the one or more cost parameters and the one or more coefficients.

13. The method of claim 12, wherein the one or more cost parameters include at least one of a speed cost parameter, a similarity cost parameter, or a jerk cost parameter.

14. The method of claim 12, wherein the one or more cost parameters include a speed cost parameter, a similarity cost parameter, and a jerk cost parameter.

15. The method of claim 11, wherein the trained coefficient-generating model is determined with a training process, the training process comprising:
obtaining a plurality of sample driving paths;
determining a plurality of samples based on the plurality of sample driving paths, wherein each of the plurality of samples includes a set of sample driving paths corresponding to a same start location and a same destination;
for each of the plurality of samples, determining a set of sample scores corresponding to the set of sample driving paths; and
determining the trained coefficient-generating model based on the scores of the plurality of samples.

16. The method of claim 15, wherein the determining the trained coefficient-generating model based on the plurality of samples includes:
obtaining a preliminary coefficient-generating model including a plurality of preliminary coefficients, wherein each of the plurality of preliminary coefficients corresponds to a sample;
extracting feature information of each of the plurality of samples;
for each of the plurality of samples, determining a set of sample travel costs corresponding to the set of sample driving paths based on a corresponding preliminary coefficient and the feature information;
determining whether a plurality of sets of sample travel costs and a plurality of sets of sample scores corresponding to the plurality of samples satisfy a preset condition; and
designating the preliminary coefficient-generating model as the trained coefficient-generating model in response to the determination that the plurality of sets of sample travel costs and the plurality of sets of sample scores satisfy the preset condition.

17. The method of claim 16, wherein the determining the trained coefficient-generating model based on the plurality of samples further includes:
updating the plurality of preliminary coefficients in response to the determination that the plurality of sets of sample travel costs and the plurality of sets of sample scores do not satisfy the preset condition, and
repeating the step of determining whether a plurality of sets of sample travel costs and a plurality of sets of sample scores corresponding to the plurality of samples satisfy the preset condition.

18. The method of claim 16, wherein the feature information of each of the plurality of samples includes velocity information of each of the set of sample driving paths and obstacle information associated with each of the set of sample driving paths.

19. The method of claim 11, wherein the identifying the target driving path from the plurality of candidate driving paths based on the plurality of travel costs corresponding to the plurality of candidate driving paths includes:
identifying a smallest travel cost from the plurality of travel costs; and
identifying a candidate driving path corresponding to the smallest travel cost as the target driving path.

20. (canceled)

21. A vehicle configured for autonomous driving, comprising:
a detecting component, a planning component, and a control component, wherein the planning component is configured to:
obtain a plurality of candidate driving paths;
obtain one or more coefficients associated with the plurality of candidate driving paths based on a trained coefficient-generating model;
determine a travel cost for each of the plurality of candidate driving paths based on the on one or more coefficients; and
identify a target driving path from the plurality of candidate driving paths based on a plurality of travel costs corresponding to the plurality of candidate driving paths.
